(19) United States
(12) Patent Application Publication
(10) Pub. No.: US 2026/0052130 A1
(43) Pub. Date: Feb. 19, 2026

(54) METHOD FOR STORING AN IDENTIFIER ON A CENTRAL COMPUTING DEVICE

(71) Applicant: MERCEDES-BENZ GROUP AG, Stuttgart (DE)

(72) Inventors: Patrick BECKER, Osnabrück (DE); Jörg ECHARD, Sindelfingen (DE); Mark GERBAN, Hamburg (DE); Martin KEPPLER, Oberreichenbach (DE)

(21) Appl. No.: 18/996,174

(22) PCT Filed: Jul. 11, 2023
(86) PCT No.: PCT/EP2023/069117

§ 371 Date: Jan. 17, 2025

(30) Foreign Application Priority Data
Jul. 19, 2022 (DE) 10 2022 002 638.4

(51) Int. Cl. H04L 9/40; G07B 15/06; G07C 5/00; H04L 9/32

(52) U.S. Cl. CPC H04L 63/0428; G07C 5/008; H04L 9/32; G07B 15/063

(57) ABSTRACT

A method for storing an identifier on a central computing device involves reading out a first identifier from a control device of a vehicle and transmitting it to a vehicle-internal computing unit for persistent storage. The first identifier is transmitted to the central OEM computing device via a cryptographically secure transmission channel and is transmitted from the central OEM computing device, after receiving a transmission order, via a cryptographically secure transmission channel to a central service provider computing device.

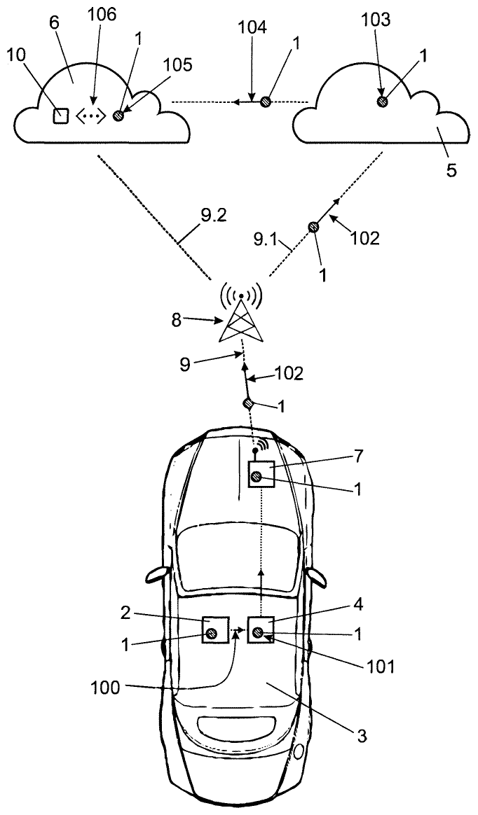

### BACKGROUND AND SUMMARY OF THE INVENTION

Exemplary embodiments of the invention relate to a method for storing an identifier on a central computing device.

With increased digitalization, the number of computing units and control devices in vehicles also increases. Such devices allow for the provision of security and convenience functions.

In some regions of the world, automatic toll systems are used. A toll control device can be integrated into a vehicle which wirelessly transmits a characteristic ID to an operator of a toll route when the vehicle enters and leaves a route subject to tolls. The toll operator can thus understand at which times which toll control device and thus which user has used which route section subject to tolls. Billing for the toll can then take place by assigning the characteristic ID of the toll control device to a user account. For this purpose, the ID must first be linked to the user account, which involves manual effort on the part of the user.

A method for authenticating a vehicle, an authentication unit, a service unit, and a vehicle-external central computer unit are known from US 2020/0327218 A1. For secure and convenient authentication of the vehicle to the service unit, the method provides that an initial value is sent from the service unit to the authentication unit in the vehicle, whereupon the authentication unit generates a vehicle test value and transmits this together with the initial value to the central computer unit. The central computer unit then generates a further vehicle test value and compares this to the received vehicle test value. If the two values match, the vehicle or the user of the vehicle is authenticated. While the further vehicle test value is being created, the central computer unit processes a table with characteristic values. Characteristic values of vehicle components are saved in this table. To create the table with the characteristic values, the authentication unit reads out the respective characteristic value from the corresponding vehicle components and transmits this to the central computer unit for saving. The method disclosed in the publication is however computationally intensive due to the frequent calculation of test values.

Exemplary embodiments of the present invention are directed to an improved method for storing an identifier on a central computing device, with the help of which user convenience for storing the identifier on the central computing device is increased and in the process computing intensity is minimized while maintaining cyber security.

A generic method for storing an identifier on a central computing device, wherein a first identifier is read out from a control device of a vehicle and is transmitted to a vehicle-internal computing unit for persistent storage and the first identifier is transmitted from the vehicle-internal computing unit to a central OEM computing device, is further developed according to the invention in that the first identifier is transmitted to the central OEM computing device via a cryptographically secure transmission channel and is transmitted from the central OEM computing device, after receiving a transmission order, via a cryptographically secure transmission channel to a central service provider computing device.

With the aid of the method according to the invention, particularly convenient and secure storage of the first identifier on the central service provider computing device is possible while maintaining cyber security. The first identifier is a piece of coded information. This information can be coded randomly, for example in any file format. The control device can be any control device, such as a toll control device or similar. The first identifier can, for example, comprise an identification number, serial number, ID, or similar of the control device or be formed by this. Further examples for the first identifier can be: a vehicle identification number, a license plate, a country or federal state in which the license plate is registered, a vehicle type, vehicle dimensions, a permissible gross vehicle weight, payment information such as a PayPal, WeChat, Alipay, Apple Pay or Google Pay account identifier, credit card information such as a credit card number or a security code, an IBAN, or similar. To transmit information between the vehicle-internal computing unit and the central OEM computing device, there is typically a communication connection. Computer data is transmitted cryptographically secured via this communication connection. As a result, the vehicle manufacturer can receive diagnostic data from the vehicle or upload software updates to the vehicle-internal computing unit. This transmission channel is present anyway and is also used according to the invention in order to securely transmit the first identifier to the central OEM computing device without any additional transformation effort for cryptographic security. For this purpose, the first identifier can for example also be integrated into a vehicle data set, for example a diagnostic data set, or be attached to this. The first identifier can however also form a separate data set.

Similarly, there is a cryptographically secure transmission channel between the central OEM computing device and the central service provider computing device. This is, for example, a hypertext transfer protocol secure connection, i.e., a communication connection based on the HTTPS internet communication protocol. Thus, separate encryption mechanisms are not required in order to ensure sufficient cyber security.

With the aid of the method according to the invention, the device ID of a toll control device can be conveniently stored with a toll system operator. Thus, there is no manual effort involved for a user of the vehicle in order to determine the device ID of the toll control device and to manually link this to their user account with the toll system operator.

The central OEM computing device is a cloud server for example, also referred to as a backend, which is operated by a vehicle manufacturer. The central service provider computing device is then a cloud server or backend of the toll system operator, for example. The first identifier is transmitted from the central OEM computing device to the central service provider computing device after a transmission order has been transmitted to the central OEM computing device. This transmission order can be manually initiated by the user of the vehicle. For this purpose, the user can use any operating device coupled with the vehicle-internal computing unit, for example a human-machine interface fixedly installed in the vehicle, such as a touch-sensitive display, or also a mobile end device coupled with the vehicle.

An advantageous further development of the method provides that the first identifier is read out from the control device during the production of the vehicle and is saved in the vehicle-internal computing unit. Therefore, the effort involved for the user of the vehicle to store the first identifier on the central service provider computing device is reduced even further. The first identifier has already been saved in the vehicle-internal computing unit when shipping the vehicle, for example. It is also possible that the first identifier is already transmitted from the vehicle-internal computing unit to the central OEM computing device before shipping the vehicle to the customer, i.e., the user.

According to a further advantageous embodiment of the method, the first identifier is read out from the control device during the service life of the vehicle and is saved in the vehicle-internal computing unit. Reading out the first identifier from the control device can also be initiated manually, for example by a user during operation or also by a dealer or mechanic during a maintenance interval in a workshop. If the user would like to register their toll control device with the toll system operator and connect it to their corresponding user account, the transmission of the first identifier can then take place only when the user so desires. Therefore, early transmission of the first identifier is prevented, which further improves cyber security, since the first identifier is saved to several storage locations for a shorter period of time and thus there is a lower potential of attack.

Transmission of the first identifier to the central OEM computing device can be initiated manually, for example by inputting a control action via an operating device of the vehicle, or also take place automatically, for example when connecting the control device to an on-board network of the vehicle, whereby initially the internal computing unit then reads out the first identifier automatically from the control device.

A further advantageous embodiment of the method further provides that the first identifier is represented on a display apparatus in the vehicle, and only after confirmation by a user inputting a control action via an operating device interacting with the vehicle-internal computing unit:
the first identifier is transmitted to the central OEM computing device; and/or
the transmission order is transmitted to the central OEM computing device.

This allows the user of the vehicle to check the first identifier before the first identifier is transmitted to the central OEM computing device or the central service provider computing device. The display apparatus can be designed as a touch-sensitive display and thus form the operating device.

In this case, it is required that the user must input confirmation for transmitting the first identifier twice. Confirmation can be required once to transmit the first identifier from the vehicle to the central OEM computing device, and a second confirmation can be required to transmit the first identifier from the central OEM computing device to the central service provider computing device.

According to a further advantageous embodiment of the method according to the invention, user data, together with the first identifier, is transmitted from the central OEM computing device to the central service provider computing device. The user data may be personal user data, such as name, address, bank information, and similar. The corresponding user data can already be present in the vehicle-internal computing unit and/or the central OEM computing device. The user of the vehicle can have a corresponding user profile with the vehicle manufacturer, for instance. As a result, convenience for the user of the vehicle is increased again, with the personal data of the user being automatically transmitted from the vehicle manufacturer to the toll system operator. Thus, the requirement that the user has to re-input their personal data to link the device ID of their toll control device to their user account with the toll system operator is eliminated.

Additionally, users are given full control over their data. Should the user desire this, for example via a corresponding setting in a user profile, each time before the user data is transferred from the central OEM computing device, i.e., also for transmission to the central service provider computing device, the user is asked whether they consent to the data transmission. The user can confirm this by inputting a corresponding control action. This prevents undesirably distributing personal information of the user, described by the user data.

A further advantageous embodiment of the method according to the invention further provides that the vehicle-internal computing unit reads the first identifier and a timestamp into a hash function for creating a hash value and the hash value together with the timestamp is transmitted to the central OEM computing device, whereupon the central OEM computing device creates the first identifier from the hash value and the timestamp by using the same hash function. Therefore, the cyber security of the method according to the invention can be further increased. The timestamp can be a point in time or a time frame, such as ±10 seconds, ±5 minutes or similar at the point in time. The point in time itself can be a point in time at which the identifier is read out from the control device of the vehicle, at which the identifier is saved in the vehicle-internal computing unit, or at which the identifier is transmitted to the central OEM computing device. If the point in time is a point in time at which the first identifier is transmitted to the central OEM computing device, the timestamp can be implicitly transmitted to the central OEM computing device by transmitting the first identifier. In other words, the central OEM computing device can also determine the timestamp itself by cross-referencing the point in time at which the first identifier is received, with the actual time. The additional concatenation of the first identifier with a timestamp enables additional cryptographic security by using a so-called time-based one-time password algorithm.

According to a further advantageous embodiment of the method, additionally, at least one second identifier is read out from the control device and is transmitted via the vehicle-internal computing unit to the central OEM computing device. The second identifier may be a feature, designed identically to the first identifier. The control device can also have a trusted platform module (TPM), from which the second identifier is read out. The second identifier may also be a unique cryptographic key for identifying the control device. In general, the second identifier can be read out from a suitable hardware and/or software component of the control device set up for this.

A further advantageous embodiment of the method furthermore provides that the second identifier is transmitted from the central OEM computing device to the central service provider computing device and the central service provider computing device uses the second identifier as an authentication feature of a user. Therefore, cyber security of the method according to the invention can be improved even further and additional functionalities can be supplied to increase user convenience. For example, authentication is possible with the second identifier and this can be used to authenticate a payment account of the user, for example. For example, carrying out credit card payments, made via a credit card network, can be enabled or confirmed by authentication of the second identifier.

Preferably, the second identifier is used for multi-factor authentication. Thus, not only the second identifier but, for example, also the first identifier and/or a third, fourth or fifth identifier are used in an authentication step. In particular, when the identifiers are cryptographic keys that can be used for a limited time, particularly secure data transmission and authentication is enabled with regard to cyber security.

Further advantageous embodiments of the method according to the invention for storing an identifier on a central computing device result from the exemplary embodiment which is described in more detail below with reference to the figure.

### BRIEF DESCRIPTION OF THE SOLE DRAWING FIGURE

Here, the sole drawing FIGURE shows a schematic representation of a transmission path for storing an identifier on a central computing device.

### DETAILED DESCRIPTION

The sole drawing FIGURE illustrates a vehicle 3 comprising a control device 2, a vehicle-internal computing unit 4 coupled therewith, and a communication unit 7 coupled therewith for wireless data transmission. The communication unit 7 can be connected for example by mobile radio to the internet. A mobile radio connection can be supplied by a mobile radio communication network 8 for forming a communication path 9. Thus, direct communication of the vehicle-internal computing unit 4 with a central OEM computing device 5 via a first communication path 9.1 and with a central service provider computing device 6 via a second communication path 9.2 is possible.

The central idea of the method according to the invention is how a first identifier 1, which is saved in the control device 2, can be transmitted to the central service provider computing device 6 in the most convenient and secure way possible.

For this purpose, in method step 100, the first identifier 1 is read out from the control device 2 and is transmitted to the vehicle-internal computing unit 4. In method step 101, the first identifier 1 is then persistently saved in the vehicle-internal computing unit 4. For this purpose, the first identifier 1 in particular is included in a vehicle data set. The vehicle data set can comprise diverse information, such as information characterizing the vehicle 3, for example a vehicle identification number, a license plate, an engine type, equipment, vehicle dimensions and similar, user data of a user of the vehicle, for example, name, date of birth, address, bank details and similar, operating data of the vehicle 3, such as current tank capacity, current charging state of a traction battery, a current movement speed, mileage and similar, or also other data.

In method step 102, the first identifier 1 is then transmitted to the central OEM computing device 5, via the communication unit 7 and the mobile radio communication network 8, preferably included in the vehicle data set. For this purpose, a cryptographically secure communication channel is used, which is available anyway since the vehicle 3 exchanges the vehicle data set with the central OEM computing device 5 over said channel. This means that no further cryptographic security measures are required to securely transmit the first identifier 1 from the control device 2 to the central OEM computing device 5. In method step 103, the first identifier 1 is then saved in the central OEM computing device 5 at least temporarily.

The first identifier 1 can be a device ID of the control device 2, for example. It can be a serial number or another characteristic reference. For example, the control device 2 may be a toll control device. A stationary toll system, which grants access to a route section subject to tolls, can receive the first identifier 1 directly from the control device 2, for example by radio, when approached by the vehicle 3, and thus enable billing for the toll. For this purpose, however, a user of the vehicle 3 must have a user account with the corresponding toll system operator. The first identifier 1 must be linked to the user account. In order to carry this out particularly conveniently, a transmission order can be initiated by the user to the central OEM computing device 5, before the vehicle 3 approaches the corresponding route section subject to tolls. For this purpose, the user can use a user interface of the vehicle 3. The transmission order can be initiated together with a command for transmitting the first identifier 1 on the central OEM computing device. Also, the user can use a mobile end device or a desktop PC to initiate the transmission order. For this, the corresponding devices only have to be in communication with the central OEM computing device. An app executed on a mobile end device, or a web browser, can serve as an interface.

In method step 104, after receiving the transmission order, the first identifier 1 is then transmitted to the central service provider computing device 6 from the central OEM computing device 5. This also happens in a cryptographically secured manner, for example using the HTTPS communication protocol.

In method step 105, the first identifier 1 is saved in the central service provider computing device 6.

In method step 106, the account of the user of the vehicle 3 is linked to the first identifier 1. To link the account to the first identifier 1, the user of the vehicle 3 can also transmit required account information 10 directly to the central service provider computing device 6 via the second communication path 9.2. This information is a unique user ID and a user password, for example. If the user has to create their account again, they also have to store their name, address, date of birth, bank billing information and similar. This account information 10 can however also be present in the central OEM computing device 5, since the manufacturer of the vehicle 3, which operates the central OEM computing device 5, also requires this information for providing diverse functionalities. If the central OEM computing device 5 receives the transmission order, the corresponding account information 10 of the user, i.e., name, address etc., together with the first identifier 1 can be transmitted from the central OEM computing device 5 to the central service provider computing device 6. As a result, the convenience for the user of the vehicle 3 is improved even further, since the manual effort involved for inputting the corresponding information is reduced. Storing the first identifier 1, in particular together with the account information 10, can be done particularly preferably by the manufacturer of the vehicle 3 during the production of the vehicle 3. This can happen in a factory or also a dealership. For this purpose, the user of the vehicle 3 can directly authorize the vehicle manufacturer for data transmission when ordering the vehicle 3. In other words, the vehicle manufacturer then creates a corresponding user account with the toll system operator or supplements such a user account.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method comprising:
reading a first identifier from a control device of a vehicle;
transmitting the first identifier to a vehicle-internal computing unit of the vehicle and storing the first identifier in persistent storage of the vehicle-internal computing unit;
transmitting, from the vehicle to a central OEM computing device via a cryptographically secure transmission channel, the first identifier;
transmitting, from the central OEM computing device to a central service provider computing device and after receiving a transmission order, the first identifier

11. The method of claim 10, wherein the first identifier is read from the control device during a production of the vehicle and is saved in the persistent storage of the vehicle-internal computing unit during the production of the vehicle.

12. The method of claim 10, wherein the first identifier is read from the control device during a service life of the vehicle and is saved in the persistent storage of the vehicle-internal computing unit during the service life of the vehicle.

13. The method of claim 10, further comprising:
displaying the first identifier on a display apparatus in the vehicle, wherein only after confirmation by a user inputting a control action via an operating device interacting with the vehicle-internal computing unit
the first identifier is transmitted to the central OEM computing device, or
the transmission order is transmitted to the central OEM computing device.

14. The method of claim 10, wherein user data is transmitted together with the first identifier from the central OEM computing device to the central service provider computing device.

15. The method of claim 10, wherein the vehicle-internal computing unit reads the first identifier and a timestamp into a hash function to create a hash value, and wherein the hash value together with the timestamp is transmitted to the central OEM computing device, whereupon the central OEM computing device creates the first identifier from the hash value and the timestamp using a same hash function.

16. The method of claim 10, wherein at least one second identifier is read from the control device and is transmitted via the vehicle-internal computing unit to the central OEM computing device.

17. The method of claim 16, wherein the second identifier is transmitted from the central OEM computing device to the central service provider computing device and the central service provider computing device uses the second identifier as an authentication feature of a user.

18. The method of claim 17, wherein the second identifier is used for multi-factor authentication.
